(19) United States
(12) Patent Application Publication
(10) Pub. No.: US 2006/0218432 A1
(43) Pub. Date: Sep. 28, 2006

(54) Method for the recognition and/or correction of memory access error electronic circuit arrangement for carrying out said method

(75) Inventors: Adrian Traskov, Steinbach (DE); Andreas Kirschbaum, Griesheim (DE); Burkart Voss, Dorndorf-Steudnitz (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/541,933

(22) PCT Filed: Dec. 2, 2003
(86) PCT No.: PCT/EP03/13527

§ 371 Date: Apr. 18, 2006

(30) Foreign Application Priority Data
Jan. 15, 2003 (DE) 103 01 310.5

(51) Int. Cl. G06F 11/00

(52) U.S. Cl. 714/5

(57) ABSTRACT

Disclosed is a system and method for the detection and/or correction of memory access errors in computer systems. Test data (P) is generated in addition to data (D) which is to be secured, using the latter data (D), and is stored inside a memory (4) in such a fashion that a particularly high rate of reliability in error detection and correction can be achieved. To this end, in addition to the data (D) to be secured, the data's addresses are taken into account according to the present system and method when generating the test data (P).

### BACKGROUND OF THE INVENTION

The present invention relates to a method for the detection and/or correction of memory access errors in a processor system, wherein test data generated in addition to data which is to be secured, using the latter data, is stored inside a memory. The invention further relates to an electronic circuit arrangement, in particular for implementing a method of this type with an error detection device connected to a processor core and to a memory.

The term ‘processor system’ in general implies individual or also network computer systems such as microcontrollers which, apart from a central processing unit (CPU) additionally comprise memories and input/output functions. These systems can be designed as systems with one processor core, or in particular several processor cores, and two or more central processing units referred to as processor cores are provided as in a multi-core system.

Methods of the above-mentioned type can be used in particular for monitoring and for error correction of memories in safety-critical applications which can be used especially in an electronic motor vehicle control element. A concept of this type may, thus, take influence on the architecture of the memory for a motor vehicle processor in particular.

In the course of technical development, electronic control units for motor vehicle brakes assume functions of the brake system at an increasing rate. In former brake systems, only the anti-lock (ABS) function was generally controlled and regulated electronically, while in more modern so-called ‘by-wire’ brake systems the complete braking function can be checked by the electronic control unit. On account of the direct safety relevance of systems of this type, there is an increasing demand in electronic motor vehicle control units offering a particularly high degree of reliability.

Usually electronic motor vehicle control units comprise programmed microprocessor systems for mastering the comparative complex functions. To improve the reliability of microprocessor systems of this type, so-called error detection systems or devices are employed which produce test data when storing data in a memory by using the data to be secured, storing the test data jointly with the data to be secured. When reading out the data again, it can be found out in a subsequent step by using the test data stored along with the first mentioned data whether a read-out error occurred.

The reliability of a motor vehicle processor system can also be improved according to DE 101 09 449 in that when reading flash memories by way of the microprocessor, parity bits are stored for each word/half word in the same memory module or in a separate memory module. Parity bits are also generated during the memory access and compared with the stored test data for the purpose of an error check.

In methods known in the art for the detection and/or correction of memory access errors, the test data is usually generated by means of error correction codes such a Hamming Code or a Berger Code and stored on the respective memory in order to correct transient errors, extend the guaranteed useful life of a product, or increase the output in the manufacture by masking manufacturing defects.

In application memories which are especially configured as a flash memory, however, only complete segments can be deleted and programmed. A flash memory with comparatively small segments requires a considerably larger surface compared to a flash memory with larger segments. Therefore, the size of the segments is limited downwards due to manufacture. As it is required to program and delete individual program parts and data parts independently of each other (both the data and the associated parity), and the smallest segment size of the parity is limited, comparatively large areas of unused memory result with system architectures of this type.

An object of the invention is to improve a method of the above-mentioned type in such a manner that a particularly high degree of reliability can be achieved in error detection and correction. Another objective is to disclose an electronic circuit arrangement which is especially appropriate for implementing the method.

### SUMMARY OF THE INVENTION

As regards the method, this object is achieved by the invention in that the data's addresses are taken into account in addition to the data to be secured when generating the test data.

Herein, the invention is based on the consideration that in previous concepts for error detection and correction, the corresponding routines or devices are integrated into the memory wrapper and allow a direct check of the data field only. Transmission errors when reading out the data, which might occur e.g. due to addressing faults or similar faults, are left unconsidered in this arrangement. In order to enhance the reliability in error detection and error correction, as the case may be, the addressing operation should therefore be included in the check. To ensure this provision in a particularly simple manner, the test data is generated by considering the data to be secured, on the one hand, and by considering its addresses, on the other hand.

Herein, a particularly high degree of reliability in error detection and error correction, as the case may be, can be reached in that, favorably, data to be secured is transmitted jointly with its associated test data to a data receiver, and the test data is evaluated for error detection only after the data transfer. Error detection and correction is thus shifted to the receiver of the data so that monitoring and error correction of both the data field and the memory wrapper with address coding and the data/address lines is safeguarded.

In a further or alternative improvement, the test data is evaluated for error detection in an error detection device checked by a checking unit. Thus, the detection and/or correction of possible errors is in turn monitored by an own checking unit. In another favorable embodiment, the checking unit produces comparative test data from data and addresses which are compared with test data of the error detection device and/or with test data of a memory connected to the error detection device. As this occurs, check bits are calculated from the corrected data and the addresses of the second CPU and compared with the possibly corrected check bits from the memory. A method of this type is, hence, appropriate in particular for the application with two or more processor cores.

To further enhance the reliability and operational safety, advantageously, separate bus lines are used for the transmission of data, test data, and addresses between the error detection device and an application memory.

As regards the electronic circuit arrangement for implementing the method including an error detection device connected to a processor core and a memory, the mentioned object is achieved in that the error detection device comprises a test data generator which generates test data for the data to be stored in the memory by way of this data and by way of its addresses.

To achieve a particularly high degree of reliability and operational safety, the error detection device is advantageously shifted out of the memory core to a receiver of the data. In this arrangement, the error detection device is favorably connected to the memory by way of a number of bus lines, and in another favorable embodiment the bus lines are separated in such a fashion that separate bus lines are respectively provided for data, test data, and addresses.

A checking unit is associated with the error detection device in another favorable embodiment.

The advantages achieved by the invention particularly involve that an especially high rate of reliability and operational safety in error detection and correction can be reached by including the addresses in the generation of the test data and, more particularly, also by shifting the error detection and correction out of the memory core into the area of a receiver for the data. This is because the addresses and in particular the address decoding logic is also examined in the error detection in addition to the actual data. Further, checking and a possible error correction of the data and address lines is ensured. The thereby attainable extension of error detection to the transmission conduits can be significant especially in external components having long connection conduits to the processor core which are comparably susceptible to disturbances.

The error detection in the address decoder is especially favorable if only one single address decoder shall be used due to design. The additionally provided checking unit for the error detection per se can, thus, be made available likewise for this error detection.

### BRIEF DESCRIPTION OF THE DRAWINGS

An embodiment of the invention will be explained in detail by making reference to the accompanying drawings. In the drawings:

FIG. 1 is a schematic view of an electronic circuit arrangement.

FIG. 2 is a schematic view of an alternative embodiment of an electronic circuit arrangement.

Like parts have been assigned like reference numerals in both of the Figures.

### DETAILED DESCRIPTION OF THE DRAWINGS

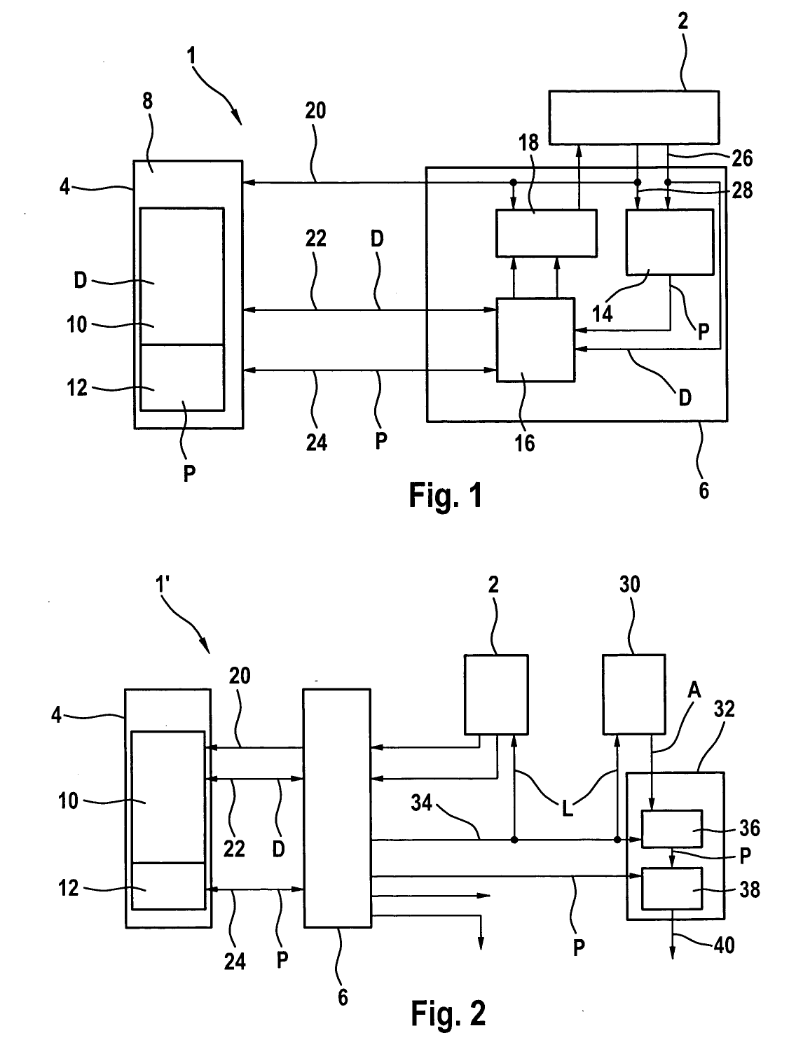

The electronic circuit arrangement 1 of FIG. 1 is provided in particular for use in the electronic control system for motor vehicle brakes. In order to ensure a particularly high rate of reliability and operational safety on account of the great safety relevance with respect to possible interventions into current driving situations, the electronic circuit arrangement 1 is designed for error detection and, as the case may be, error correction in data processing operations. For this purpose, the electronic circuit arrangement 1 comprises an error detection device 6 which is connected at the data end between a processor core 2 also referred to as central processing unit or CPU, and a memory 4 associated therewith. The special purpose of the error detection device 6 is to safeguard a high rate of reliability of the read-out data D when relaying data D from the memory 4 into the processor core 2, and to reliably detect any errors found and correct them, if needed.

The memory 4, in which data D is stored, comprises a memory area 10 for data D and another memory area 12 for test data P associated with data D in addition to a memory wrapper 8 provided for the address decoding and memory management.

The error detection device 6 comprises a test data generator 14, a bus logic device 16, and a correction block 18. The error detection device 6 is connected to the memory 4 by way of a number of bus lines 20, 22, 24, and the bus line 20 is provided in the type of an address line for transmitting address data to the memory wrapper 8, the bus line 22 is provided in the type of a data line for transmitting data D to the memory segment 10, and the bus line 24 is provided in the type of a code line for transmitting test data to the memory segment 12.

To safeguard a particularly high rate of reliability in error detection and, as the case may be, error correction, the error detection device 6 is designed to generate the test data P provided for the data D to be secured, on the one hand, in consideration of data D, yet also in consideration of its addresses, on the other hand. To this end, the test data generator 14 on the inlet side is connected to the processor core 2 both by way of a data line 26 and by way of a branch line 28 connected to the first bus line 20 provided as an address line. The test data P thus generated in consideration of data D and the addresses can subsequently be transferred from the test data generator 14 to the bus logic device 16, from where data is relayed by way of the bus line 24 to the memory 4 for storage.

In addition, the circuit arrangement 1 is designed to evaluate the test data P for error detection only after the data transmission to a receiver for data D. The error detection device 6, while avoiding integration into the memory 4, is configured as a separate component connected to the memory 4 by way of bus lines 20, 22, 24 to this end. In the evaluation of the data D read out of the memory 4 and the test data P associated with data D in the correction block 18, in which also the addresses are considered, error detection is thus carried out not only for the actual data D but also for the transmission lines and addresses required for the data transmission.

The electronic circuit arrangement 1 in the embodiment of FIG. 1 is configured as a processor unit with only one processor core. In contrast thereto, the embodiment of FIG. 2 shows an embodiment with two processor cores wherein a further processor core 30 designed as CPU is provided in addition to the first processor core 2. In this embodiment a checking unit 32 being configured as an error detection device is moreover associated with the error detection device 6. In this arrangement, the error detection device 6 supplies by way of a data line 34 reading data L to the first processor core 2 and also to the second processor core 30. Reading data L represents data already corrected by the error detection device 6. The reading data L is further sent to a check bit generator 36 in the checking unit 32 which generates test data or check bits P by way of the reading data L and addresses A submitted by the second processor core 32. The test data or check bits are compared in a comparison unit 38 with corrected check bits or test data P transmitted by the error detection device 6 so that the proper functioning of the error detection device 6 can be checked. The comparison module 38 sends an error message as an output signal through its outlet channel 40 in case of need. The same applies to the checking unit 6, through the outlet channel 41.

1-10. (canceled)

11. A method for the detection and/or correction of memory access errors in a processor system, the method comprising:
storing data which is to be secured in a memory; and
storing test data in the memory (4) in addition to the data which is to be secured, wherein in addition to the data to be secured, addresses of the data are taken into account when generating the test data.

12. The method of claim 11, wherein the data to be secured is transmitted jointly with associated test data to a data receiver, and the test data is evaluated for error detection only after the data transfer.

13. The method of claim 12, wherein the test data is evaluated for error detection in an error detection device that is checked by a checking unit.

14. The method of claim 13 further comprising:
generating further test data to check the error detection device by way of data supplied by the error detection device and the addresses of the data.

15. The method of claim 13, wherein the checking unit produces comparative test data from data and addresses which are compared with at least test data of the error detection device or with test data of a memory connected to the error detection device.

16. The method of claim 13, wherein separate bus lines are used for the transmission of data, test data, and addresses between the error detection device and an application memory.

17. An electronic circuit arrangement, for the detection and/or correction of memory access errors in a processor system, the electronic circuit arrangement comprising:
an error detection device;
a processor core connected to the error correction device; and
a memory connected to the error detection device, wherein the error detection device includes a test data generator which generates test data for data to be stored in the memory by way of the data and addresses of the data.

18. The electronic circuit arrangement of claim 17, wherein the error detection device is connected to the memory by way of one or more bus lines.

19. The electronic circuit arrangement of claim 18, wherein separate bus lines are respectively provided for data, test data, and addresses.

20. The electronic circuit arrangement of claim 17, wherein a checking unit is associated with the error detection device.
